(19) United States
(12) Patent Application Publication
(10) Pub. No.: US 2025/0370717 A1
(43) Pub. Date: Dec. 4, 2025

(54) Random number generating method using geometric graphs and cellular automaton distribution.

(71) Applicant: Leith Tidwell, Provo, UT (US)

(72) Inventor: Leith Tidwell, Provo, UT (US)

(73) Assignee: Leith Tidwell, Provo, UT (US)

(21) Appl. No.: 18/680,952

(22) Filed: May 31, 2024

(51) Int. Cl. G06F 7/58

(52) U.S. Cl. CPC G06F 7/582

(57) ABSTRACT

The present invention is a method for generating random numbers using discrete randomized geometric graphs and cellular automaton mechanisms. Number generators often fail to provide unpredictable results which pass tests for statistical randomness. The present invention method increases unpredictability while meeting the tests for cryptographic random number generation.

### BACKGROUND OF THE INVENTION AND PRIOR ART

Random number sequencing is the process through which a series of numbers that cannot be predicted better than by random chance are generated. Most random number generators contain a particular outcome sequence based upon the principal mathematical method of calculation making their outputs appear random but which are in fact predetermined.

### DESCRIPTION OF THE INVENTION

The present invention method improves upon existing random number generators through use of hyperbolic geometric graphs to generate number sequences for use in cellular automaton number sampling. This method is accomplished by using the method as shown here:
1) generate hyperbola using vertices at point of origin.
2) sample random numbers from hyperbolic geometric graph using inverse probability integral transform.
3) generate hyperbola with random numbers sampled in Step 2 as vertices.
4) sample random numbers from hyperbolic geometric graph using inverse probability integral transform.
5) generate a cellular automaton distribution using the random number set generated in Step 4 with Rule 30 as the baseline rule. Odd random numbers are assigned the binary value of 1 and even random numbers are assigned the binary value of 0.
6) use random number set range obtained from hyperbolic geometric graph sampling in Step 4 for selection of cellular automaton seed (n).
a) pick center column and batch (n)-bits at a time with one bit per generation forming (n)-bit random number.
b) use seed value (n) to advance forward (n) iterations.
c) use generated bits to form random number sequence within assigned range.

### EXAMPLE EMBODIMENTS

The present invention method can use multiple equations, graphs, and curves to establish a random number sequence. These include, but are not limited to, hyperbolic geometric graphs, inverse probability integral transform, and cellular automaton distributions. The method can also be utilized using other geometric graph types in the initial random number generation steps.

### OBJECTS AND ADVANTAGES

A new method of random number generation is created using hyperbolic geometric graph sampling and cellular automaton distributions. This method allows for random number generation through randomized seed key creation in a manner restrictive of mirroring of the invented method.

1. The invention is a method for generating random numbers using geometric graphs and cellular automaton distributions. This method provides random number sequences by sampling hyperbolic geometric graphs and cellular automaton distributions.
